(19) United States
(12) Patent Application Publication
(10) Pub. No.: US 2007/0283250 A1
(43) Pub. Date: Dec. 6, 2007

(54) Document Processing Method and System

(76) Inventors: Akitoshi Tsukamoto, Gunma (JP); Michiyo Hiramoto, Saitama (JP); Yasuhiro Mitsui, Saitama (JP)

Correspondence Address: RABIN & Berdo, PC, 1101 14TH STREET, NW, SUITE 500, WASHINGTON, DC, 20005, US

(21) Appl. No.: 10/590,143

(22) PCT Filed: Feb. 17, 2005
(86) PCT No.: PCT/JP05/02958

§ 371 Date: May 8, 2007

(30) Foreign Application Priority Data
Feb. 23, 2004 (JP) 2004-045935

(51) Int. Cl. G06F 15/00

(52) U.S. Cl. 715/530

(57) ABSTRACT

The present invention provides a document processing method which can be realized even in an ordinary document processing device such as a document copying machine. The document processing method provides easy document editing. The document processing method includes a document creation step which creates a document, and a document editing step which edits the document on the basis of editing information specific to the document. The document creation step includes an original creation step which creates the original of the document, and an embedding step which embeds the editing information in the document. The document editing step includes an extraction step which extracts the editing information embedded in the document, and a modifying step which modifies the document from the original state on the basis of the editing information. The present invention also provides a document processing system for executing the document processing method.

### TECHNICAL FIELD

The present invention relates to a document processing method for creating and editing documents and system of the same.

### BACKGROUND ART

Image processing devices such as electronic copying machines, scanner devices and facsimile transmission devices basically have the function of performing image processing such as the copying, reading and transmission of documents on which image information is printed. Such image processing devices may also have a document editing function which allows editing such as erasure, blackening and replacement by other patterns of specified regions on the basis of editing information that is designated in advance or written into the documents.

For example, the image processing device disclosed in Japanese Patent Application Laid-Open (Kokai) No. 10-255027 stores a document, which is a printed document obtained from an electronic original, with document ID information being attached to the document. When the printed document is scanned, the corresponding electronic original is called up by designating the document ID information, and this is compared with the scanned image. If there is a greater-than-specified difference between the electronic original and the scanned image, the called-up electronic original is printed out because it is determined that the scanned image (i.e., the printed document) includes additional work.

When the document processing system disclosed in Japanese Patent Application Laid-Open No. 2003-018393 performs the document printing, the image to be printed is first divided into a plurality of pieces, and these pieces are stored as original document images. Then, marks associated with these original document images are additionally printed on the documents when the printing is carried out. When the printed documents are scanned, these marks are read, and the corresponding original document images are called up. Whether additional work has been made to the original document(s) is determined by means of the image differences between these original document images and scanned images.

The image information editing device disclosed in Japanese Patent Application Laid-Open No. 5-292294 creates a single synthetic copy from a plurality of originals. This device reads originals in which the marks designating the image information that is to be synthesized are indicated, originals of the image information, and layout originals that determine the output layout. Thus, a copy output in which image information corresponding to the marks is synthesized according to the output layout can be obtained.

The methods disclosed in Japanese Patent Application Laid-Open No. 10-255027 and Japanese Patent Application Laid-Open No. 2003-018393 should store electronic originals or original document images in order to obtain information about additional work made to the originals, and this is difficult to realize in a simple device such as a copying machine or the like. The method disclosed in Japanese Patent Application Laid-Open No. 5-292294 should recognize a layout original that is separate from the original document, so that this method cannot be used if only the original document is available. This makes the handling difficult.

### DISCLOSURE OF THE INVENTION

It is one object of the present invention to provide a document processing method which can be realized in an ordinary document processing device such as a document copier, and in which document editing can easily be utilized.

It is another object of the present invention to provide a system for executing the document processing method.

According to a first aspect of the present invention, there is provided a method for processing a document. The document processing method includes a document creation step which creates the document, and a document editing step which edits the document on the basis of editing information specific to the document. The document creation step includes an original creation step that creates the original of the document, and an embedding step that embeds the editing information in the document. The document editing step includes an extraction step that extracts the editing information embedded in the document, and a modifying step that modifies the document from the original state on the basis of the editing information.

According to a second aspect of the present invention, there is provided a system for processing a document. The document processing system includes a document creation means for creating the document, and a document editing means for editing the document on the basis of editing information specific to the document. The document creation means includes an original creation means for creating the original of the document, and an embedding means for embedding the editing information in the document. The document editing means includes an extraction means for extracting the editing information embedded in the document, and a modifying means for modifying the document from the original state on the basis of the editing information.

According to a third aspect of the present invention, there is provided a method for creating a document that is to be edited on the basis of editing information. The document creating method includes an original creation step of creating the original of the document, and an embedding step of embedding the editing information in the document.

According to a fourth aspect of the present invention, there is provided a device for creating a document that is to be edited on the basis of editing information. The document creation device includes an original creation means for creating the original of the document, and an embedding means for embedding the editing information in the document.

According to a fifth aspect of the present invention, there is provided a method for editing a document on the basis of editing information embedded by an embedding step. The document editing method includes an extraction step of extracting the editing information embedded in the document, and a modifying step of modifying the document from the original state on the basis of the editing information.

According to a sixth aspect of the present invention, there is provided a device for editing a document on the basis of editing information embedded by an embedding means. The document editing device includes an extraction means for extracting the editing information embedded in the document, and a modifying means for modifying the document from the original state on the basis of the editing information.

According to a seventh aspect of the present invention, there is a document of which original image is to be edited on the basis of editing information. The original image is converted into the document of paper or electronic form. This document has the editing information which is embedded by an embedding means.

### BRIEF DESCRIPTION OF THE DRAWINGS

FIG. 1 is a block diagram showing the construction of a document processing system according to a first embodiment of the present invention;

FIG. 2A is a flow chart of the printed matter preparation of the document processing system shown in FIG. 1;

FIG. 2B is a flow chart of the printed matter editing of the document processing system shown in FIG. 1;

FIG. 3 shows an example of an original image used in the document processing system shown in FIG. 1;

FIG. 4 shows an example of editing information in the document processing system shown in FIG. 1;

FIG. 5 shows a printing result of the original having embedded information, obtained from the document processing system shown in FIG. 1;

FIG. 6 shows a printing output following editing in the document processing system shown in FIG. 1;

FIG. 7 is a block diagram showing the construction of a document processing system according to a second embodiment of the present invention;

FIG. 8A is a flow chart of printed matter preparation in the document processing system shown in FIG. 7;

FIG. 8B is a flow chart of printed matter editing in the document processing system shown in FIG. 7;

FIG. 9 shows an example of an original image which is processed by the document processing system shown in FIG. 7;

FIG. 10 shows editing information in the document processing system shown in FIG. 7;

FIG. 11 shows a printing result of the original having embedded information, obtained from the document processing system shown in FIG. 7;

FIG. 12 shows an example of printing output following editing in the document processing system shown in FIG. 7;

FIG. 13 is a block diagram showing the construction of a document processing system according to a third embodiment of the present invention;

FIG. 14A is a flow chart of printed matter preparation in the document processing system shown in FIG. 13;

FIG. 14B is a flow chart of printed matter editing in the document processing system shown in FIG. 13;

FIG. 15 shows an example of an original image used in the document processing system shown in FIG. 13;

FIG. 16 shows editing information in the document processing system shown in FIG. 13;

FIG. 17 shows the printing result of the original having embedded information, obtained from the document processing system shown in FIG. 13;

FIG. 18 shows a document having an added-writing (retouch), which is processed by the document processing system shown in FIG. 13;

FIG. 19 shows a result of the added-writing detection in the document processing system shown in FIG. 13; and

FIG. 20 shows a printing output following editing in the document processing system shown in FIG. 13.

### MODE FOR CARRYING OUT THE INVENTION

### Embodiment 1

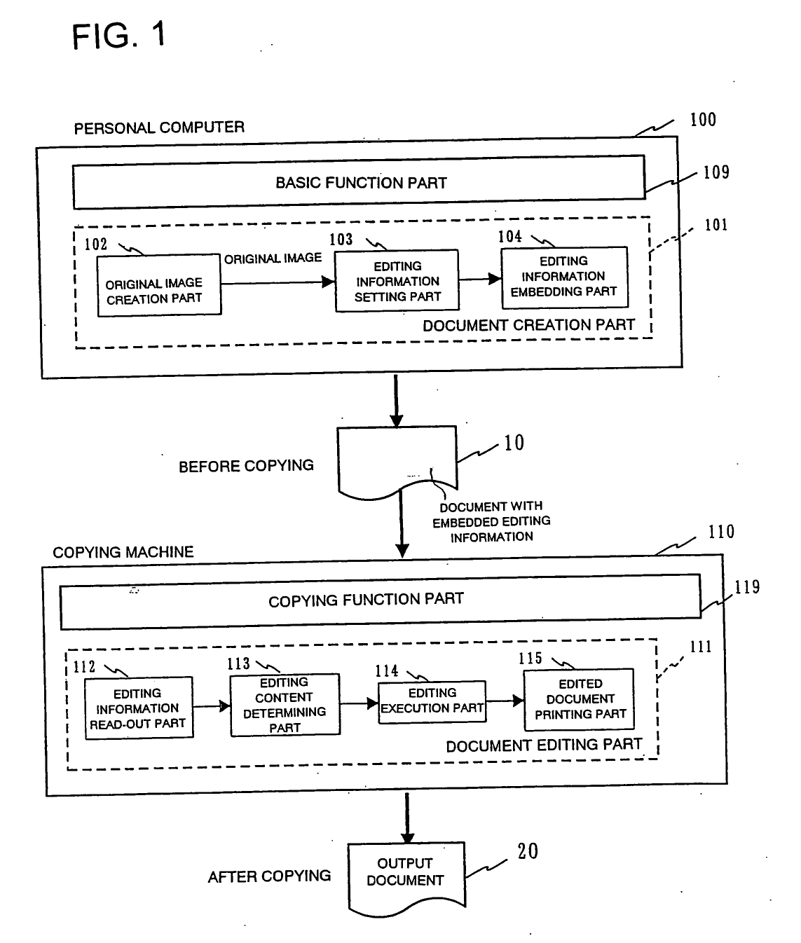

Referring to FIG. 1, the construction of a document processing system in a first embodiment of the present invention will be described. This document processing system includes a personal computer 100 and a copying machine 110. The personal computer 100 creates a document 10 with embedded editing information. The editing information-embedded document 10 includes the original image such as characters and/or graphic images, and also includes the editing information that is necessary in order to perform editing of the image information. The editing information is embedded in the document 10. Therefore, the content of the editing information cannot be visually confirmed by a person, or is difficult to be confirmed by a person. Later, for example, when there is a need to copy the document, the editing information-embedded document 10 is placed into the copying machine 110. The copying machine 110 copies the original image of the document 10, and prints an output document 20 in which editing has been performed on the original image.

The personal computer 100 has a basic control part 109 that realizes ordinary computer functions such as display, input-output, calculations and the like, and a document creation part 101. The document creation part 101 has the function of creating document originals, the function of embedding information that is required in order to edit these document originals, and the function of printing the document originals. The document creation part 101 has an original image creation part 102, an editing information setting part 103, and an embedding part 104. These parts of the document creation part 101 can be realized by means of software.

The original image creation part 102 creates originals by means of programs such as word processing software, and produces original images by converting the originals into image data by means of programs such as image conversion software. The editing information setting part 103 has the function of setting the editing information that is required for editing, such as designation of one or more specified regions in the created original images. The editing information embedding part 104 has the function of embedding encoded data obtained by encoding the editing information in the original images.

The method of embedding the editing information in the original images in the editing information embedding part 104 is, for example, a bar code method. Alternatively, it is preferred that the editing information is embedding as an electronic watermark in the printed matter such that the editing information is hidden in the background of the printed matter without occupying a particular area in the document, as disclosed in Japanese Patent Application Laid-Open No. 2003-101762. The entire disclosure of Japanese Patent Application Laid-Open No. 2003-101762 is incorporated herein by reference. Even more preferably, the editing information is embedded in a dispersed manner over the entire surface of the document so that all the editing information can be embedded even in a limited paper size. It should be noted that the editing information may be embedded with some redundancy so that the document editing is possible even if a portion of the paper surface is lost.

The original images having the editing information embedded therein are printed by a printer as the documents 10. The editing information-embedded documents 10 may be issued as electronic documents without being printed out in the form of printed matter, and may be transmitted on line to the copying machine 110.

The copying machine 110 includes an ordinary copying functional part 119 that creates duplicate copies of the documents, and a document editing part 111. The copying machine 110 may also have a function to electronically receive the document 10 if the document 10 is issued in the form of electronic document. The document editing part 111 has a function that performs editing work in accordance with the embedded editing information when making a copy of the document 10 in the form of printed matter, or when printing the electronic document. The document editing part 111 also has a function that outputs the edited document. The document editing part 11 has an editing information read-out part 112, an editing content determining part 113, an editing execution part 114, and an edited document printing part 115. These respective parts of the document editing part 111 can be realized mostly by means of software.

The editing information read-out part 112 has the function of extracting the content of the editing information by reading the image information on the surface of the document 10 as document information when the editing information-embedded document 10 is copied, and decoding and reading the editing information embedded by the electronic watermark or bar code method. The editing content determining part 113 has the function of determining what kind of editing is to be performed on the document image using the editing information including the extracted editing conditions and other decorative information. The editing execution part 114 actually executes editing of the document image, and modifies the original image. The edited document printing part 115 prints the edited document image.

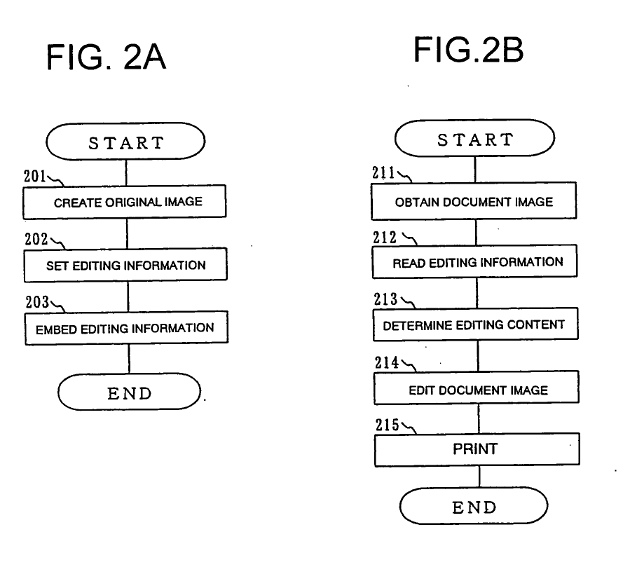

FIG. 2A shows the processing in the document creation part 101 of the document processing system. FIG. 2B shows the processing in the document editing part 111. These processing will be described with reference to the constituent elements shown in FIG. 1.

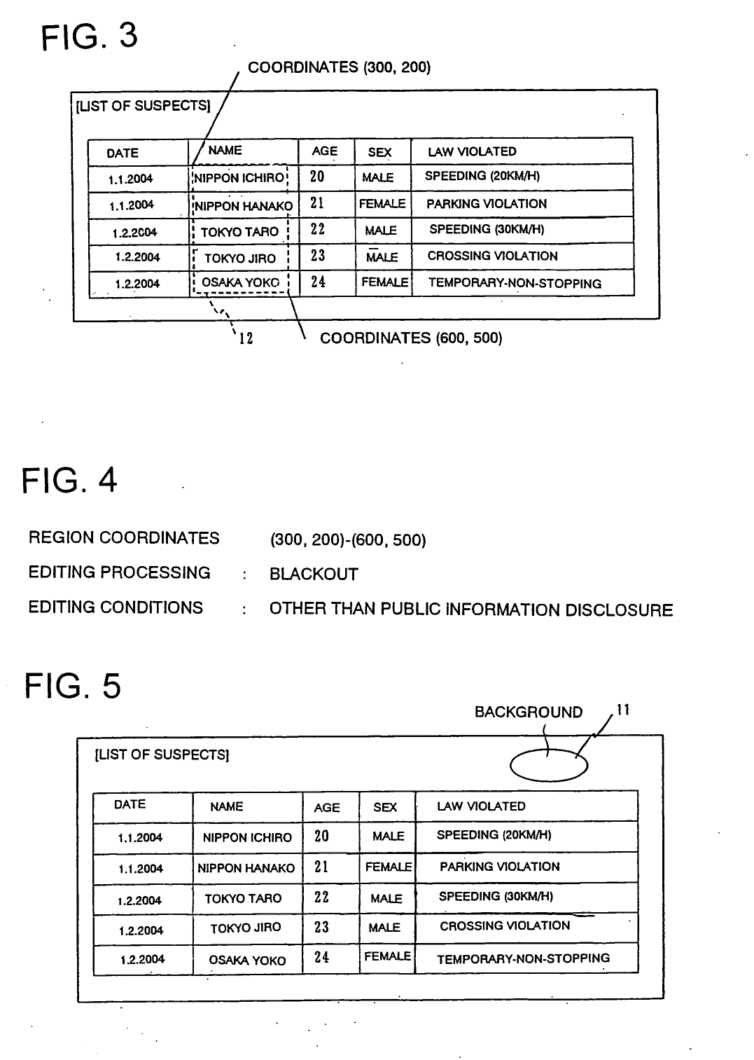

First, the processing routine performed in the document creation part 101 shown in FIG. 2A will be described. In step 201, the original image of the document is created by the original image creation part 102. This can be executed using word processing software, or image conversion software. An example of a created original image is shown in FIG. 3. The portion surrounded by the broken line in FIG. 3 is a region that is defined as a region to be blacked out at the time of copying or at the time of printing of an electronic document, as long as there is no command to the contrary by the operator.

In step 202, the editing information that is required for editing processing is decided in the editing information setting part 103. FIG. 4 shows an example of the editing information in a case where blackout processing is performed on the original image as shown in FIG. 3. The editing information of FIG. 4 indicates the coordinates of the specified region 12 in which blackout is to be performed, the content of the editing processing (i.e., blackout), and the conditions for triggering the editing processing (i.e., the blackout is to be performed only in cases where copies are made or electronic documents are printed for purposes other than public information disclosure).

In step 203, the editing information is embedded in the original image by the editing information embedding part 104. FIG. 5 shows the original image in which the editing information is embedded as an electronic watermark. When the embedding is performed using an electronic watermark, the editing information is embedded as the background 11 of the document as shown in FIG. 5. For example, the original image having the embedded editing information is printed by a printer as the document 10, or is issued in the form of electronic document.

The operation of the document editing part 111 shown in FIG. 2B will now be described. First, in step 211, the editing information-embedded document 10 is scanned to obtain a document image, or the electronic document is converted to an image to obtain a document image. Next, in step 212, the editing information is read from the document image by the editing information read-out part 112. An approach suitable for the embedded editing information is used for this processing; for example, if the document has information embedded by means of an electronic watermark, the reading-out of step S212 is performed using the method described in Japanese Patent Application Laid-Open No. 2003-101762. The entire disclosure of Japanese Patent Application Laid-Open No. 2003-101762 is incorporated herein by reference.

In step 213, the editing content is determined by the editing content determining part 113. The required information is entered into the copying machine 110 by the operator, and the editing content is determined using the content of this operator input and the editing information. For example, if a copy of the document shown in FIG. 5 is made, the operator is prompted to enter the purpose of utilization of the copy. If the entered purpose of utilization is public information disclosure, then editing is not performed, and the document image is printed “as is” as an output document 20.

In step 214, editing work on the document image is executed by the editing execution part 114. In the case of the example shown in FIG. 5, the editing work is the blacking out of the specified region 12 indicated in the editing information; the pixels of the specified region 12 of the document image are blacked out. In order to have an accurate position for the blacking out, it is necessary to correct the inclination and the like of the document image. A very accurate position correction can be accomplished by performing a position correction using a background pattern that is embedded in the entire document as shown in FIG. 5, and preferably also using the electronic watermark.

It should be noted that the electronic watermark, bar code or the like used in order to embed the editing information in the document image is removed by a method such as binarization and cutting prior to the execution of editing. It should also be noted that the read-out editing information may be re-embedded in the document image by means of electronic watermark, bar code or the like. This will make it possible to edit the output document (copy) 20 again, after the copy 20 is produced from the copying machine 110.

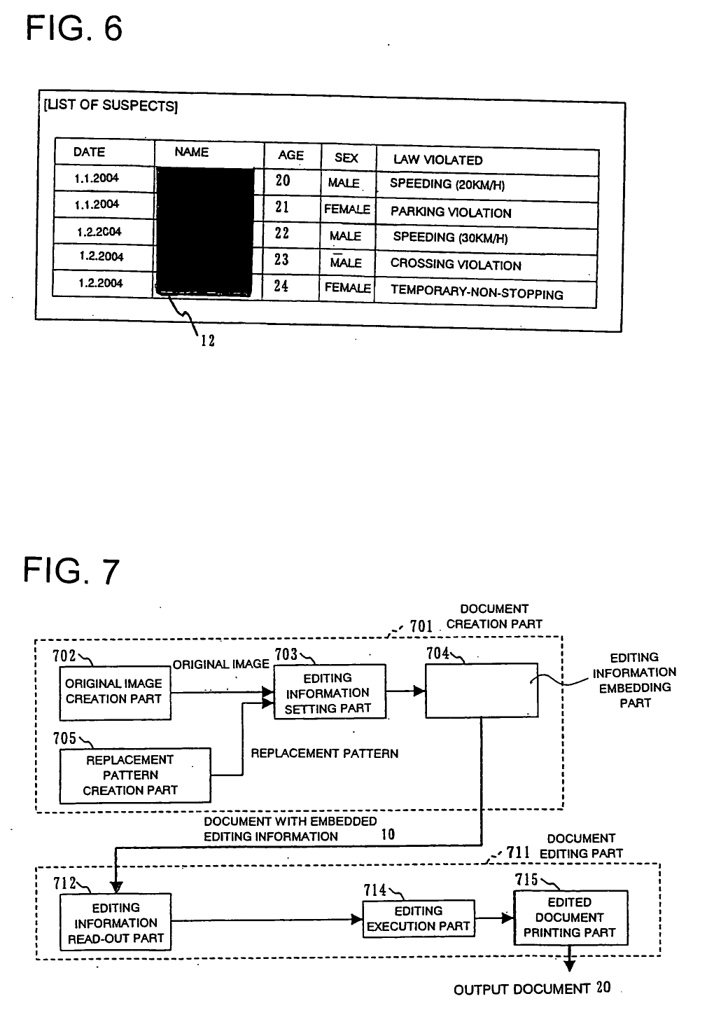

In step 215, the edited document image is printed as the output document 20 by the edited document printing part 115. An example of printing output is shown in FIG. 6. The pixels of the specified region 12 are blacked out.

In the first embodiment, the document that is to be copied can be copied after being subjected to editing processing such as blackout in accordance with the editing information that is embedded in this document. As a result, unnecessary parts of the document can be eliminated, and important parts of the document can be provided to the person in question. In the illustrated embodiment, the editing work is the blacking out of unnecessary portions. However, the color that is applied is not limited to black. As a modification of this, editing that performs various types of decoration such as the application of a mesh to important parts of the document, the embedding of underlining and the like is possible. It would also be possible to register overwriting patterns beforehand in the copying machine 110, so that the user can select a certain pattern and overwrite the region specified in the editing information with the selected pattern.

### Embodiment 2

FIG. 7 shows the construction of a document processing system in a second embodiment of the present invention. If the second embodiment is compared with the first embodiment, the second embodiment has a separate pattern to replace the content of the document. If the system shown in FIG. 7 is compared with the system of the first embodiment, the system of FIG. 7 has a replacement pattern creation part 705 which is additionally provided in the document creation part 701 in the personal computer 100. Also, the document editing part 711 of the copying machine 110 does not have the part corresponding to the editing content determining part in FIG. 1. The replacement pattern creation part 705 has the function of creating a replacement pattern that is to be substituted for the specified region of the original image.

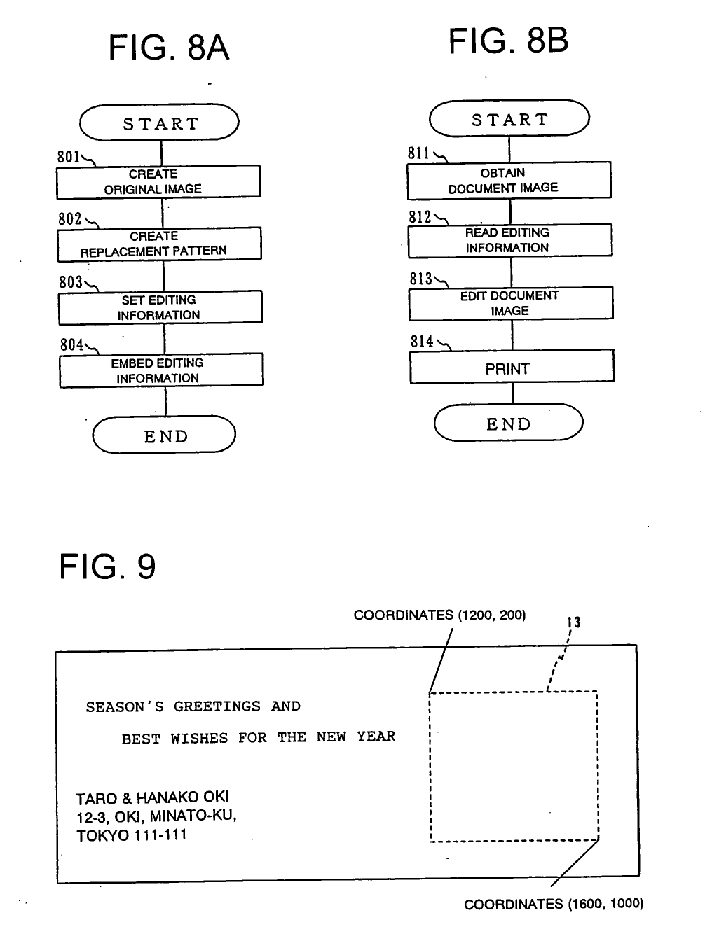

FIG. 8A shows the processing routine in the document creation part 701 of the document processing system of the second embodiment. FIG. 8B shows the processing routine in the document editing part 711.

First, the operation in the document creation part 701 shown in FIG. 8A will be described. In step 801, the original image of the document is created by the original image creation part 702. This is executed using word processing software and image conversion software installed in an ordinary personal computer. An example of the created original image is shown in FIG. 9. In FIG. 9, the specified region 13 surrounded by the broken line is a region that is to be replaced by a separately designated replacement pattern. Next, in step 802, a replacement pattern is created. This is executed by designating (selecting) appropriate existing image data, or by using image editing software installed in the personal computer. Next, in step 803, the editing information that is required for editing processing is set by the editing information setting part 703.

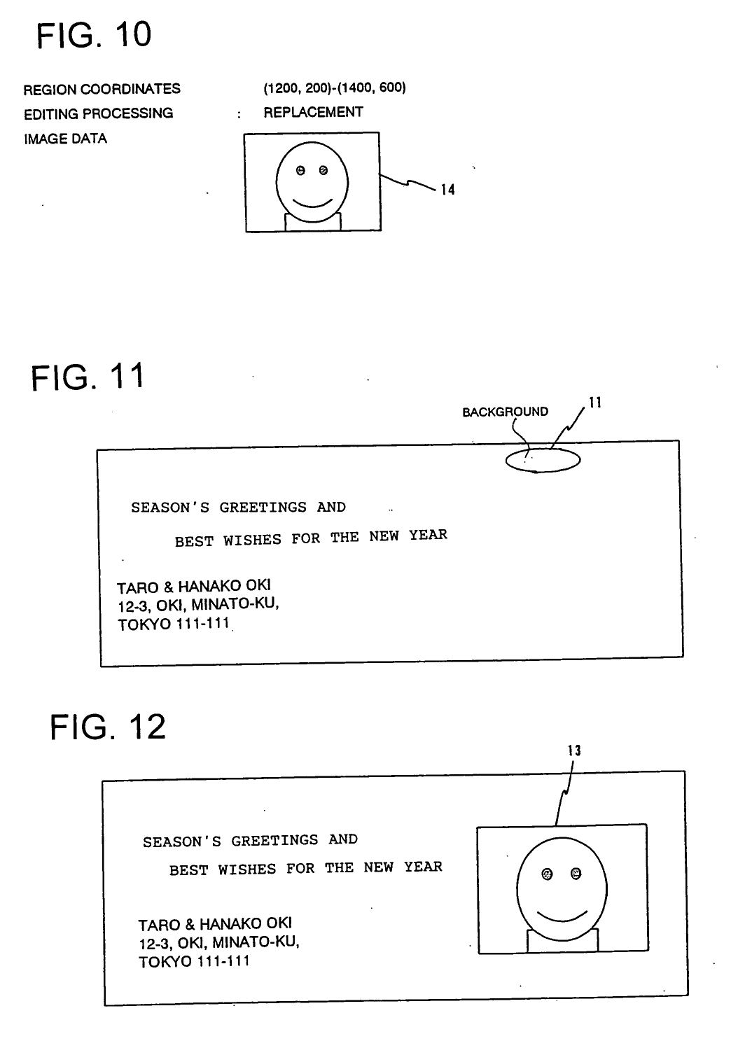

FIG. 10 shows an example of editing information used to replace a portion of the document image shown in FIG. 9. In FIG. 10, the editing information includes the coordinates of the specified region 13 that is to be replaced, the content of the editing processing, i.e., replacement, and the data of the replacement pattern 14.

Referring again to FIG. 8A, in step 804, the editing information is embedded in the original image by the editing information embedding part 704. An example in which the editing information is embedded as an electronic watermark is shown in FIG. 11.

In cases where embedding is performed using an electronic watermark, the editing information is embedded as the background 11 of the document as shown in FIG. 11. For example, the original image having the editing information embedded therein is printed by a printer as an editing information-embedded document, or is issued as an electronic document. If a quantity of the editing information is too large to be embedded using only an electronic watermark, then another method using bar code or the like may additionally be employed to complete the embedding of the editing information.

The processing routine of the document editing part 711 shown in FIG. 8B will now be described.

In step 811, the editing information-embedded document 10 is scanned, or the electronic document is converted into an image, so that a document image is acquired. Next, in step 812, the editing information is read out from the document image by the editing information read-out part 712. This processing is performed using a method suited for the embeded editing information.

In step 813, editing work is executed on the document image by the editing execution part 714. In the example shown in FIG. 11, replacement is performed for the specified region indicated in the editing information. If the size of the specified region that is to be replaced is different from the size of the replacement pattern, the replacement pattern is expanded or contracted to fit the size of the specified region. It should be noted that the electronic watermark, bar code or the like which is used to embed the editing information is removed by a method such as binarization and cutting prior to the execution of editing. It should also be noted that the editing information may be embedded once again in the document image by means of electronic watermark and bar code or the like.

In step 814, the edited document image is printed as an output document 20 by an edited document printing part 715. An example of the printing output is shown in FIG. 12. Replacement of the specified region 13 is accomplished by means of a replacement pattern 14 (see FIG. 10).

In the second embodiment, as described above, the replacement processing can be executed in accordance with the editing information including the replacement pattern embedded in the document, and then the document is printed.

### Embodiment 3

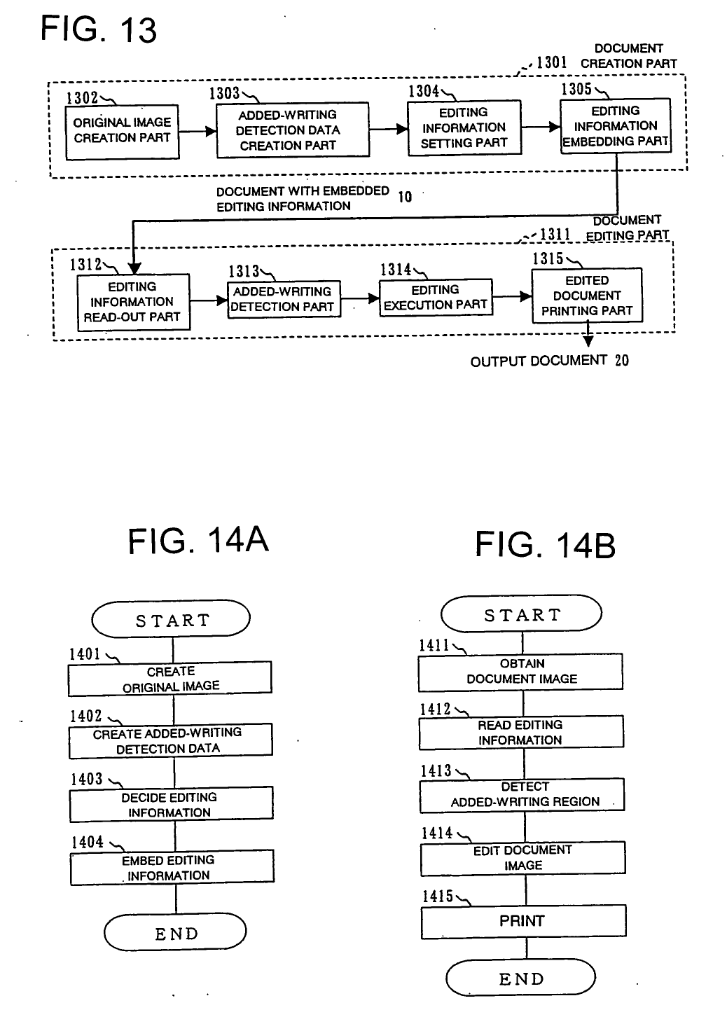

FIG. 13 shows the construction of a document processing system in a third embodiment of the present invention. The third embodiment, when compared with the first embodiment, can detect writing (retouch) added to the document, and erase the added writing when making a copy. When the system shown in FIG. 13 is compared with the system of the first embodiment, an added-writing detection data creation part 1303 is provided in the document creation part 1301, and the editing content determining part of the document editing part 111 in FIG. 1 is replaced by an added-writing detection part 1313. The added-writing detection data creation part 1303 creates reference data (e.g., a compressed or reduced image of the original image, or coordinate data indicating the blank region (white region) of the original image) used to detect a location of the added writing (retouch) from a document image that includes the added writing. The added-writing detection part 1313 has a function of detecting the retouch by manual notation means such as a pencil to the editing information-embedded document 10 if there is such an addition.

FIG. 14A shows the processing routine in the document creation part 1301 of the document processing system, and FIG. 14B shows the processing routine in the document editing part 1311. These processing routines will be described with reference to the constituent elements shown in FIG. 13.

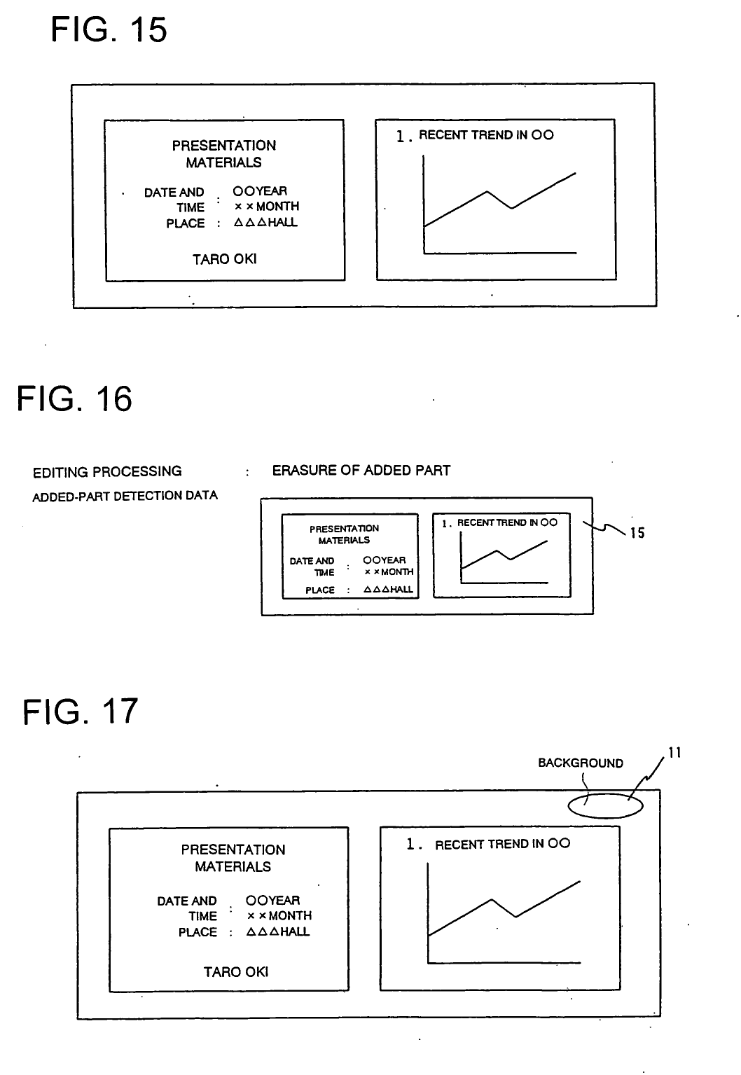

First, the operation in the document creation part 1301 shown in FIG. 14A will be described. In step 1401, the original image of the document is created by the original image creation part 1302. This is executed using ordinary word processing software or image conversion software. An example of a created original image is shown in FIG. 15.

In step 1402, the data required for the added-writing detection is created by the added-writing detection data creation part 1303. For example, the data required for the added-writing detection is a compressed or reduced image of an original image and/or coordinate data of a blank region of the original image. This data is reference data used to detect an added-writing location from a document image that includes added-writing. The method disclosed in Japanese Patent Application Laid-Open No. 2003-209676 is a method in which information required for the detection of retouch or modification is embedded as an electronic watermark. If this method is utilized, the number of signals embedded in the original image is used as the data required for the added-writing detection. The entire disclosure of Japanese Patent Application Laid-Open No. 2003-209676 is incorporated herein by reference.

In step 1403, the editing information required for editing processing is set by the editing information setting part 1304. An example of editing information in a case where the added portion to the original image shown in FIG. 15 should be erased is shown in FIG. 16. In FIG. 16, the editing processing content of “erasure of added part” is included in the editing information, and the reduced image 15 is included as data that is required for added-part detection.

In step 1404, the editing information is embedded in the original image by the editing information embedding part 1305. An example in which the editing information is embedded as an electronic watermark is shown in FIG. 17. If embedding is performed using an electronic watermark, the editing information is embedded as the background 11 of the document as shown in FIG. 17. For example, the original image in which the editing information has been embedded is printed by a printer as the editing information-embedded document 10, or is issued as an electronic document.

The processing routine of the document editing part 1311 shown in FIG. 14B will now be described.

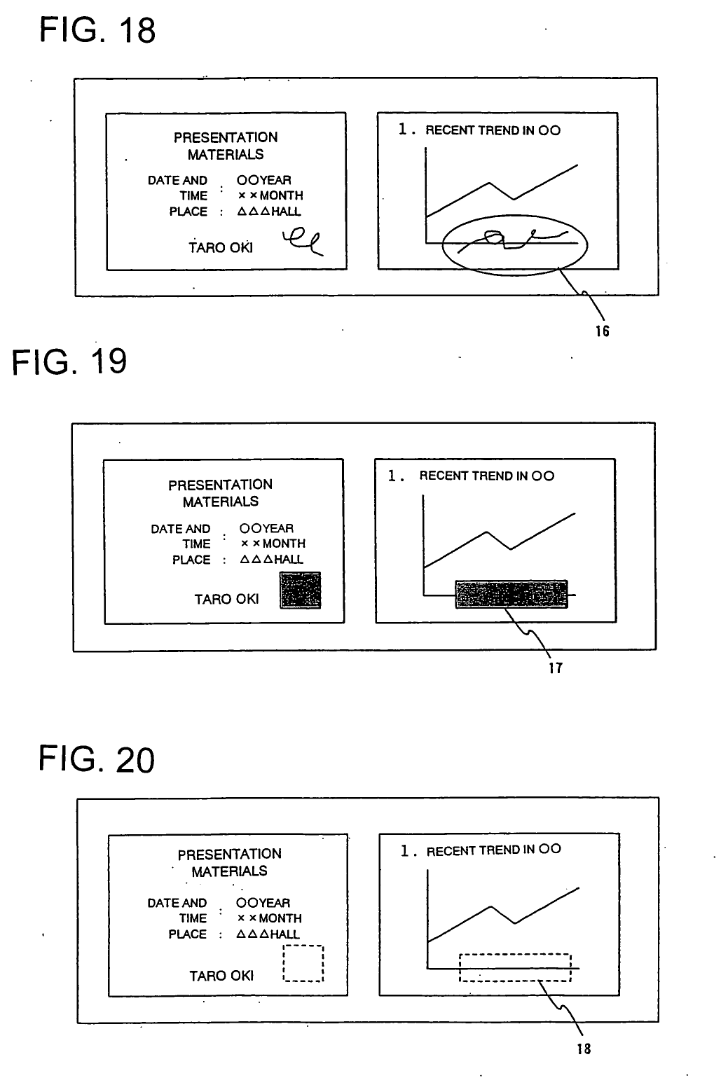

First, in step 1411, a document image is acquired by scanning or image conversion of the editing information-embedded document 10. An example of a document image which includes an added-writing is shown in FIG. 18. The added writing 16 is shown in FIG. 18.

In step 1412, the editing information is read from the document image by the editing information reading part 1312. This processing is performed using a method suited for the embedded editing information.

In step 1413, the area of the added writing is detected by the added-writing detection part 1313. This detection is carried out based on the content of the added-writing detection data contained in the editing information. For example, if a compressed image or reduced image of the original image is contained in the editing information, the compressed or reduced image is expanded and compared with the document image in question to find out the area of the added writing. If the coordinate data of the blank (white areas) in the original image is contained in the editing information, locations that are now “not blank” in the originally blank area of the document image are detected. If the method disclosed in Japanese Patent Application Laid-Open No. 2003-209676 is used, the area of the added-writing can be detected as the area of the modified portion. An example of the result of added-writing detection is shown in FIG. 19. In FIG. 19, the added-writing area 17 is detected.

In step 1414, editing work on the document image is executed by the editing execution part 1314. This paints the detected region 17 with a single color, i.e., the pixels in this region are whited out or painted out by a specified color. It should be noted that if straight lines are contained in the region 16 as shown in FIG. 18, these straight lines may be detected, and the detected straight lines may be redrawn after the added-writing region is entirely painted with a single color. If compressed or reduced image of the original image is contained in the added-writing detection data, the original characters and the like can be restored by expanding the compressed or reduced image and copying (overwriting) the expanded image onto the document image.

The electronic watermark, bar code or the like that is used to embed the editing information is removed by a method such as binarization, cutting out or the like, prior to the editing process. It should be noted that the editing information may be again embedded in the document image by a method means of an electronic watermark, bar code or the like.

In step 1415, the edited document image is printed as a duplicate image 20 by the edited document printing part 1315. An example of printing results is shown in FIG. 20. The regions 18 indicated by the broken line in FIG. 20 are those portions which are detected in the added-wiring detection process in FIG. 19. It can be seen from FIG. 20 that the added-writing is erased and the straight lines are restored.

The third embodiment can erase the added portions from the document prior to the printing of the document, in accordance with the editing information embedded in the document.

In the document processing method and system of the present invention, as understood from the above described embodiments, information that is required for editing work and for the acquisition of added information is embedded in a document during the creation of the document. When a document is read in for copying, transmission or the like, this information is extracted and editing such as blackout, replacement, and erasure of added portions can be performed. Such editing can also be realized in a single device such as a copying machine or facsimile device. Since this document editing function uses editing information embedded in the document itself, there is no need for the advance preparation or retention of other documents (e.g., original documents and editing layouts) than the document concerned, so that utilization of this function is easy.

In the application of the document processing method and system of the present invention, the document creation part is realized as personal computer software, and the document editing part is realized as control software of a copying machine. However, such software can also be integrated as control software of a composite or hybrid machine. Alternatively, this can be realized by software installed in a personal computer to which the printer and/or scanner is connected.

The editing information-embedded document prepared by the document creation part can be printed, and/or can also be utilized as a file with an electronic document format. In the latter case, the data input into the document editing part is accomplished not by the scanning of a printed matter (i.e., the editing information-embedded document), but rather by the conversion of electronic document file data into images.

The overwriting pattern used to erase unnecessary parts in a document, and the replacement pattern used to perform the replacement processing of document need not always be stored inside the copying machine or embedded in the document; for example, IDs that specify patterns may be embedded as editing information, and replacement patters corresponding to these IDs may be acquired from a data base that is connected via a network.

Decorations in the document editing may include diverse decorative features. For example, portions for which copying is prohibited are blacked out at the time of copying, portions which include added writing are erased before printing, or illustrations such as frames and icons desired by the user are inserted before printing.

This application is based on Japanese Patent Application No. 2004-45935 filed on Feb. 23, 2004, and the entire disclosure of this Japanese patent application is incorporated herein by reference.

### INDUSTRIAL APPLICABILITY

The application of the document processing method and system of the present invention is not limited to systems including a personal computer and copying machine; this method and system can also be used in systems combining a device capable of document creation such as a word processing device, and an image processing device such as a facsimile device and a scanner device.

1: A document processing method for processing a document, comprising:
a document creation step of creating said document; and
a document editing step of editing said document on the basis of editing information specific to said document,
wherein said document creation step includes an original creation step that creates an original of said document, and
an embedding step that embeds said editing information in said document, and
wherein said document editing step includes an extraction step that extracts the editing information embedded in said document, and a modifying step that modifies said document from the original state on the basis of said editing information.

2: The document processing method according to claim 1, wherein said embedding step is a step in which encoded data obtained by encoding said editing information is embedded in said document by means of electronic watermark.

3: The document processing method according to claim 1, wherein said embedding step is a step in which encoded data obtained by encoding said editing information is embedded in said document by means of bar code.

4: The document processing method according to claim 1, wherein said editing information includes decorative information that is required in order to decorate a specified region in said document, and said modifying step includes a decorating step that decorates the specified region in said document on the basis of said decorative information.

5: The document processing method according to claim 4, wherein said decorative information includes information which indicates whether or not decoration is to be performed.

6: The document processing method according to claim 5, wherein said decorative information includes coordinate information indicating said specified region.

7: The document processing method according to claim 4, wherein said decorating step decorates the specified region of said document with a designated color.

8: The document processing method according to claim 4, wherein said decorating step decorates the specified region by half-tone dot meshing.

9: The document processing method according to claim 4, wherein said decorating step decorates the specified region by overwriting the specified region with an overwriting pattern.

10: The document processing method according to claim 9 further comprising a registration step of registering said overwriting pattern beforehand.

11: The document processing method according to claim 1, wherein said editing information includes replacement information that is required in order to replace the specified region of said documents with the replacement pattern, and said modifying step replaces the specified region of said document with said replacement pattern on the basis of said replacement information.

12: The document processing method according to claim 11, wherein said replacement information includes coordinate information that indicates said specified region.

13: The document processing method according to claim 11, wherein said replacement information includes said replacement pattern.

14: The document processing method according to claim 11, wherein said replacement information includes information that designates said replacement pattern.

15: The document processing method according to claim 11, further comprising means for registering said replacement pattern beforehand.

16: The document processing method according to claim 1, wherein said editing information includes retouched-part information required in order to detect a retouched part added to said document, and said modifying step erases said retouched part added to said document on the basis of said retouched-part information.

17: The document processing method according to claim 16, wherein said retouched-part information includes a compressed image or reduced image of said document.

18: The document processing method according to claim 16, wherein said retouched-part information includes coordinate data indicating a blank region of said document.

19: The document processing method according to claim 16, wherein said retouched-part information includes a number of signals embedded in said document.

20: The document processing method according to claim 16, wherein said modifying step erases the retouched part added to said document by painting out said retouched part with a specified color.

21: The document processing method according to claim 20, wherein said modifying step erases the retouched part added to said document by painting out said retouched part with the specified color except for a straight line existing within said retouched part.

22: The document processing method according to claim 17, wherein said modifying step erases the retouched part added to said document by restoring an image of said document using said retouched-part information.

23: The document processing method according to claim 1, further comprising a step of removing said editing information from said document following said modifying step.

24: The document processing method according to claim 1, further comprising a re-embedding step of updating said editing information so as to reflect a result of the editing performed by said modifying step, and then embedding the updated editing information in said document following said modifying step.

25: A document processing system which processes a document, comprising:
document creation means for creating said document; and
document editing means for editing said document on the basis of editing information specific to said document,
wherein said document creation means includes original creation means for creating the original of said document, and embedding means for embedding said editing information in said document, and
wherein said document editing means includes extraction means for extracting the editing information embedded in said document, and modifying means for modifying said document from said original state on the basis of said editing information.

26: The document processing system according to claim 25, wherein said embedding means embeds encoded data, which is obtained by encoding said editing information, in said document using an electronic watermark.

27: The document processing system according to claim 25, wherein said embedding means embeds encoded data, which is obtained by encoding said editing information, in said document using a bar code.

28: The document processing system according to claim 25, wherein said system includes any one of an electronic copying machine, a scanner device and a facsimile device.

29: The document processing system according to claim 25, further comprising a server device which holds either an overwriting pattern or replacement pattern used by said document editing means, or both, and which supplies the overwriting or replacement pattern to said document editing means via a network.

30: The document processing system according to claim 29, wherein said server device includes means for registering either said overwriting pattern or replacement pattern, or both.

31: A document creation method for creating a document that is to be edited on the basis of editing information, comprising:
an original creation step of creating an original of said document; and
an embedding step of embedding said editing information in said document.

32: The document creation method according to claim 31, wherein said embedding step embeds encoded data, which is obtained by encoding said editing information, in said document using an electronic watermark.

33: The document creation method according to claim 31, wherein said embedding step embeds encoded data, which is obtained by encoding said editing information, in said document using a bar code.

34: The document creation method according to claim 31, wherein said editing information includes decorative information that is required in order to decorate a specified region of said document.

35: The document creation method according to claim 34, wherein said decorative information includes information that indicates whether or not decoration is to be performed.

36: The document creation method according to claim 35, wherein said decorative information includes coordinate information indicting said specified region.

37: The document creation method according to claim 31, wherein said editing information includes replacement information that is required in order to replace the specified region of said document with a replacement pattern.

38: The document creation method according to claim 37, wherein said replacement information includes coordinate information that indicates said specified region.

39: The document creation method according to claim 37, wherein said replacement information includes said replacement pattern.

40: The document creation method according to claim 37, wherein said replacement information includes information that designates said replacement pattern.

41: The document creation method according to claim 37, wherein said editing information includes retouched-part information that is required in order to detect a retouched part added to said document.

42: The document creation method according to claim 41, wherein said retouched-part information includes a compressed image or reduced image for said document.

43: The document creation method according to claim 41, wherein said retouched-part information includes coordinate data indicating a blank region in said document.

44: The document creation method according to claim 41, wherein said retouched-part information includes a number of signals embedded in said document.

45: A document creation device for creating a document that is to be edited on the basis of editing information, comprising:
original creation means for creating an original of said document; and
embedding means for embedding said editing information in said document.

46: The document creation device according to claim 45, wherein said embedding means embeds encoded data, which is obtained by encoding said editing information, in said document using an electronic watermark.

47: The document creation device according to claim 45, wherein said embedding means embeds encoded data, which is obtained by encoding said editing information, in said document using a bar code.

48: The document creation device according to claim 45, wherein said device includes a personal computer.

49: A document editing method for editing a document on the basis of editing information embedded by an embedding step, comprising:
an extraction step of extracting the editing information embedded in said document; and
a modifying step of modifying said document from the original state on the basis of said editing information.

50: The document editing method according to claim 49, wherein said embedding step embeds encoded data, which is obtained by encoding said editing information, in said document using an electronic watermark.

51: The document editing method according to claim 49, wherein said embedding step embeds encoded data, which is obtained by encoding said editing information, in said document using a bar code.

52: The document editing method according to claim 49, wherein said editing information includes decorative information that is necessary in order to decorate a specified region in said document, and said modifying step includes a decorating step that decorates the specified region in said document on the basis of said decorative information.

53: The document editing method according to claim 52, wherein said decorative information includes information that designates whether or not decoration is to be performed.

54: The document editing method according to claim 53, wherein said decorative information includes coordinate information that indicates said specified region.

55: The document editing method according to claim 52, wherein said decorating step decorates a specified region of said document by painting said region with a designated color.

56: The document editing method according to claim 52, wherein said decorating step decorates the specified region by half-tone dot meshing.

57: The document editing method according to claim 52, wherein said decorating step decorates the specified region by overwriting the specified region with an overwriting pattern.

58: The document editing method according to claim 57, further comprising a registration step which registers said overwriting pattern beforehand.

59: The document editing method according to claim 49, wherein said editing information includes replacement information that is necessary in order to replace the specified region of said document with the replacement pattern, and said modifying step replaces the specified region of said document with said replacement pattern on the basis of said replacement information.

60: The document editing method according to claim 59, wherein said replacement information includes coordinate information indicating said specified region.

61: The document editing method according to claim 59, wherein replacement information includes said replacement pattern.

62: The document editing method according to claim 59, wherein replacement information includes information that designates said replacement pattern.

63: The document editing method according to claim 59, further comprising means for registering said replacement pattern beforehand.

64: The document editing method according to claim 49, wherein said editing information includes retouched-part information that is necessary in order to detect a retouched part added to said document, and said modifying step erases the retouched part added to said document on the basis of said retouched-part information.

65: The document editing method according to claim 64, wherein said retouched-part information includes a compressed image or reduced image of said document.

66: The document editing method according to claim 64, wherein said retouched-part information includes coordinate data that indicates a blank region in said document.

67: The document editing method according to claim 64, wherein said retouched-part information includes a number of signals embedded in said document.

68: The document editing method according to claim 64, wherein said modifying step erases the retouched part added to said document by painting out said retouched part with a specified color.

69: The document editing method according to claim 68, wherein said modifying step erases the retouched part added to the said document by painting out said retouched part with the specified color except for a straight line located inside said retouched part.

70: The document editing method according to claim 65, wherein said modifying step erases the retouched part added to said document by restoring the image of said document using said retouched-part information.

71: The document editing method according to claim 49, further comprising a step of erasing said editing information from said document following said modifying step.

72: The document editing method according to claim 49, further comprising a re-embedding step of updating said editing information so as to reflect a result of the editing performed by said modifying step, and then embedding the updated editing information in said document following said modifying step.

73: A document editing device for editing a document on the basis of editing information embedded by embedding means, comprising:
extraction means for extracting the editing information embedded in said document; and
modifying means for modifying said document from the original state on the basis of said editing information.

74: The document editing device according to claim 73, wherein said embedding means embeds encoded data, which is obtained by encoding said editing information, in said document using an electronic watermark.

75: The document editing device according to claim 73, wherein said embedding means embeds encoded data, which is obtained by encoding said editing information, in said document using a bar code.

76: The document editing device according to claim 73, wherein said device includes any one of an electronic copying machine, a scanner device and a facsimile device.

77: A document of which original is to be edited on the basis of editing information, wherein the original is converted into the document of paper or electronic form, and said editing information is embedded in the document by embedding means.

78: The document according to claim 77, wherein said embedding means embeds encoded data, which is obtained by encoding said editing information, in said document using an electronic watermark.

79: The document according to claim 77, wherein said embedding means embeds encoded data, which is obtained by encoding said editing information, in said document using a bar code.

80: The document according to claim 77, wherein said editing information includes at least one of decorative information that is necessary in order to decorate a specified region in said document, replacement information that is necessary in order to replace the specified region of said document with a replacement pattern, and retouched-part information that is necessary in order to detect the retouched part added to said document.
